(19) United States
(12) Patent Application Publication
(10) Pub. No.: US 2016/0205247 A1
(43) Pub. Date: Jul. 14, 2016

(54) METHOD FOR PRESENTING A TITLE IN AN AUDIO CALL

(71) Applicant: Kola Voice Technologies (Israel) Ltd., Tel-Aviv (IL)

(72) Inventors: Tal ELYASHIV, Ramat-HaSharon (IL); Yoseph Taguri, Tel-Aviv (IL); Shmuel Ur, Shorashim (IL)

(21) Appl. No.: 14/596,506

(22) Filed: Jan. 14, 2015

(51) Int. Cl. H04M 3/436; H04M 3/02

(52) U.S. Cl. CPC H04M 3/4365; H04M 3/02

(57) ABSTRACT

A method for presenting a title in an audio phone call, comprising: receiving a phone call destination address and a phone call title from an initiating client terminal, the phone call destination address and the phone call title are received via a user interface of the initiating client terminal; initiating a phone call from the initiating client terminal to a receiving client terminal corresponding to the phone call destination address; and sending the phone call title to the receiving client terminal to be presented on the receiving client terminal with an indication of a pending phone call.

### FIELD AND BACKGROUND OF THE INVENTION

The present invention, in some embodiments thereof, relates to methods and systems of initiating or tagging an audio call, such as a phone call and, more particularly, but not exclusively, to initiating a voice over internet protocol (VoIP) phone call, with a title and/or completing a phone call under defined conditions.

When a phone call is initiated, whether by regular telephony system or by voice over internet protocol (VoIP), the receiving end of the call is usually presented a pending call and with a caller identification (ID) that may include some information about the caller, such as phone number, name and/or description.

The receiver of the phone call typically has a few options when presented with a pending call. The receiver may answer the call, may reject the call, may reject the call and send a message to the initiator of the call or may do nothing and therefore miss the call.

### SUMMARY OF THE INVENTION

According to an aspect of some embodiments of the present invention there is provided a method for presenting a title in an audio phone call, comprising: receiving a phone call destination address and a phone call title from an initiating client terminal, the phone call destination address and the phone call title are received via a user interface of the initiating client terminal; initiating a phone call from the initiating client terminal to a receiving client terminal corresponding to the phone call destination address; and sending the phone call title to the receiving client terminal to be presented on the receiving client terminal with an indication of a pending phone call.

Optionally, the sending includes creating an invite packet having a header, the header includes the phone call title.

Optionally, the method further comprises: performing the following by the receiving client terminal: presenting on a user interface of the receiving client terminal an option to reject the pending phone call and a subset of a plurality of optional response messages, the subset is selected from the plurality of optional response messages according to the phone call title; receiving via the user interface of the receiving client terminal a selected response message from the subset; terminating the pending phone call; and sending the selected response message.

More optionally, the subset is selected according to a natural language processing (NLP) algorithm operated on the phone call title.

More optionally, the subset is selected according to previously selected response messages by a plurality of users in response to previous phone call titles.

Optionally, the method further comprises: storing an entry of the pending phone call in a dataset, the entry includes the phone call title; and querying the dataset to retrieve the entry.

More optionally, the entry further includes the selected response message.

Optionally, the receiving via the user interface includes: presenting on the user interface a plurality of optional phone call titles; and receiving via the user interface a selected phone call title from the plurality of optional phone call titles.

Optionally, the receiving via the user interface includes: presenting on the user interface a subset of a plurality of optional phone call titles, the subset is selected from the plurality of optional phone call titles according to the phone call destination address; and receiving via the user interface a selected phone call title from the subset.

Optionally, the receiving includes a plurality of phone call destination addresses corresponding to a plurality of receiving client terminals.

According to some embodiments of the invention there is provided a computer readable medium comprising computer executable instructions adapted to perform the method.

According to an aspect of some embodiments of the present invention there is provided a method for presenting a title in an audio phone call, comprising: receiving via a user interface of an initiating client terminal, a phone call destination address and a phone call title; initiating a phone call from the initiating client terminal to a receiving client terminal corresponding to the phone call destination address; and sending the phone call title from the initiating client to the receiving client terminal to be presented on the receiving client terminal.

According to an aspect of some embodiments of the present invention there is provided a system for presenting a title in an audio phone call, comprising: an initiating client terminal that receives, via a user interface, a phone call destination address and a phone call title; a server that receives the phone call destination address and the phone call title from the initiating client terminal and initiates a pending phone call; and a receiving client terminal corresponding to the phone call destination address that receives a pending phone call and the phone call title from the server, and presents an indication of the pending phone call and the phone call title.

According to an aspect of some embodiments of the present invention there is provided a method for presenting a title in an audio phone call, comprising: receiving from an initiating client terminal, a phone call destination address, the phone call destination address is received via a user interface of the initiating client terminal; sending the phone call destination address from the initiating client terminal to a server; initiating a phone call from the initiating client terminal to a receiving client terminal corresponding to the phone call destination address; receiving from the initiating client terminal a phone call title, the phone call title received via the user interface; and sending the phone call title to the receiving client terminal to be presented on the receiving client terminal.

According to an aspect of some embodiments of the present invention there is provided a method for completing a phone call, comprising: receiving from an initiating client terminal, a phone call destination address; sending a request for initiating a phone call to a receiving client terminal corresponding to the destination address; receiving at least one availability condition from at least one of the initiating client terminal and the receiving client terminal; and when the at least one availability condition is fulfilled, automatically initiating a phone call between the initiating client terminal and the receiving client terminal.

Optionally, the at least one availability condition includes a predefined time period.

Optionally, the at least one availability condition includes a location of at least one of the initiating client terminal and the receiving client terminal.

Optionally, the at least one availability condition includes non-presence of other people in proximity to at least one of the initiating client terminal and the receiving client terminal.

Optionally, the at least one availability condition includes a required duration for the phone call, wherein the duration is an available duration according to a calendar stored in at least one of the initiating client terminal and the receiving client terminal.

Optionally, the at least one availability condition includes a required duration for the phone call, wherein the duration is a predicted duration of a journey.

Optionally, the at least one availability condition includes an activity performed by a user of at least one of the initiating client terminal and the receiving client terminal.

Optionally, the at least one availability condition received from the at least one of the initiating client terminal and the receiving client terminal is presented on the other of the initiating client terminal and the receiving client terminal.

Optionally, an indication of partial fulfillment of the at least one availability condition received from the at least one of the initiating client terminal and the receiving client terminal is presented on the other of the initiating client terminal and the receiving client terminal.

Optionally, the receiving includes a plurality of phone call destination addresses corresponding to a plurality of receiving client terminals.

According to some embodiments of the invention there is provided a computer readable medium comprising computer executable instructions adapted to perform the method.

According to an aspect of some embodiments of the present invention there is provided a system for completing a phone call, comprising: an initiating client terminal that receives, via a user interface, a phone call destination address; a receiving client terminal corresponding to the destination address that receives a request for initiating a phone call; a server that receives at least one availability condition from at least one of the initiating client terminal and the receiving client terminal; and when the at least one availability condition is fulfilled, automatically initiates a phone call between the initiating client terminal and the receiving client terminal.

According to an aspect of some embodiments of the present invention there is provided a method for initiating a phone call, comprising: receiving from an initiating client terminal, a phone call destination address; sending a request for initiating a phone call to a receiving client terminal corresponding to the destination address; receiving from the receiving client terminal instructions to initiate a phone call between the initiating client terminal and the receiving client terminal and to send a message to the initiating client terminal, the instructions are received via a user interface of the receiving client terminal by a single action of a user of the receiving client terminal; and initiating the phone call and sending the message.

Optionally, the single action includes a member of a group consisting of a single button press, a single finger press, a single finger gesture and a voice command.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a system for initiating communication between client terminals, by using phone call title and/or availability condition(s), according to some embodiments of the present invention;

FIG. 2 is a flowchart schematically representing a method for presenting a title in an audio phone call, according to some embodiments of the present invention;

FIG. 3 is an exemplary user interface for selecting phone call title, according to some embodiments of the present invention; and

FIG. 4 is a flowchart schematically representing a method for completing a phone call under defined conditions, according to some embodiments of the present invention.

### DESCRIPTION OF EMBODIMENTS OF THE INVENTION

The present invention, in some embodiments thereof, relates to methods and systems of initiating a phone call and, more particularly, but not exclusively, to initiating or tagging an audio call, such as a voice over internet protocol (VoIP) phone call, with a title and/or completing a phone call under defined conditions.

As used herein, the term phone call may refer to a VoIP phone call, a video call, and/or any other form of real-time and/or synchronous communication.

According to some embodiments of the present invention, there is provided a method of adding a textual phone call title or graphical call marker, multimedia phone call marker or call icon, all for brevity referred to herein as a phone call title, to messages for triggering a phone call establishment, for example to the header of VoIP messages. The phone call title may be defined by an initiator of the call, using a user interface of an initiating client terminal, such as a mobile phone or a computer. The call title is added to a message containing a phone call identifier and a phone call destination address such as a phone number and/or a username. The phone call title may be defined or edited by a receiver of the call, using a user interface of a receiving client terminal, such as a mobile phone or a computer. The phone call title may describe the subject of the phone call, an indication of the urgency of the call and/or any other information. The phone call title may include text, image(s), video and/or voice recording. The user interface of an initiating client terminal may include suggested or previously defined call titles for the initiator to select from, for example according to the phone call destination address.

The phone call destination address and the phone call title are sent to the server and a phone call is initiated between the initiating client terminal and a receiving client terminal that matches the phone call destination address. The pending phone call is presented on the receiving client terminal with the phone call title.

The receiver of the phone call, using the receiving client terminal, may then have the option of answering, rejecting or ignoring the call, or responding to the call with a message, based on the caller identification (ID) and based on the phone call title. Possible messages or templates of messages may be suggested to the receiver, based on the phone call title, for example according to keywords in the phone call title's text.

Phone call titles of past phone calls may be stored in a dataset, located on the initiating client terminal, the receiving client terminal and/or a remote server accessible via the client terminal(s). The dataset may be quarried by the initiator and/or by the receiver in order to locate a specific past phone call according to the phone call title.

According to some embodiments of the present invention, there is provided a method of completing a phone call when defined conditions are fulfilled. The method allows a call that cannot happen at a certain time, due to unavailability, be completed at a later time when availability conditions are fulfilled.

A phone call destination address is received by a server from an initiating client terminal and a request to initiate a phone call is sent to a receiving client terminal that matches the phone call destination address. The initiator and/or the receiver may then define one or more availability condition for initiating the phone call between the initiating client terminal and the receiving client terminal, such as a time and/or a location. When the availability condition(s) is fulfilled, the server automatically initiates the phone call.

According to some embodiments of the present invention, there is provided a user interface that allows a user of a client terminal to instruct simultaneously, for instance by a single button press, a reception of an audio or video call and a transmission of a user selected message to an initiator of the audio or video call.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

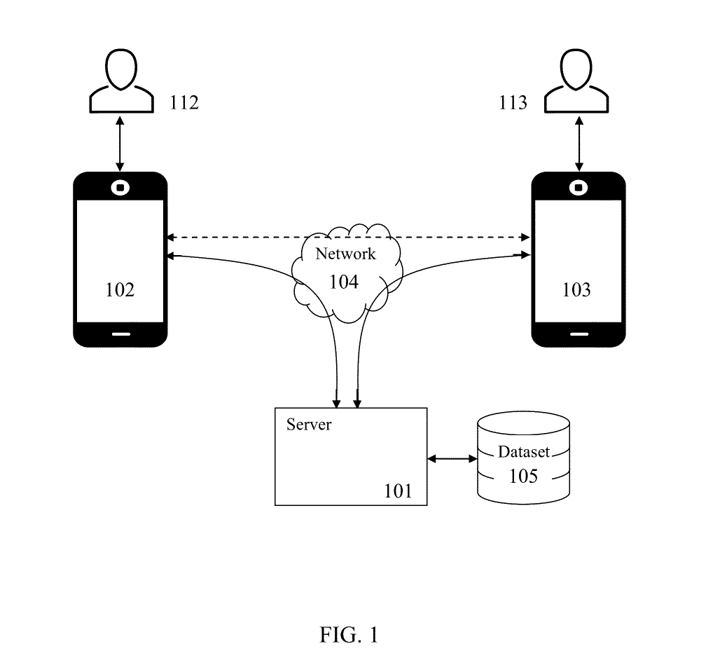

Referring now to the drawings, FIG. 1 is a schematic illustration of a system for initiating communication between client terminals, by using phone call title and/or availability condition(s), according to some embodiments of the present invention.

System 100 includes a server 101 and at least two client terminals, an initiating client terminal 102 and a receiving client terminal 103, used by at least two users, initiator 112 and receiver 113. Server 101 is a remote server accessible via the client terminal(s) and may include one or more computing devices, for example, a mainframe computer, an enterprise server, a workstation, multiple connected computers and/or a personal computer. Client terminals 102 and 103 may include, for example, a mobile device such as a Smartphone, a tablet, a wearable device such as Google glass, a Smart watch, a laptop computer and/or the like, a personal computer and/or any device that has one or more network communication modules, such as a network card or chip and runs a web-browser. Each client terminal may include a program such as an App Store application or a Google Play application installed in the client terminal, a native operating system application and/or a browser add-on. Server 101 is connected to client terminals 102 and 103 via a network 104. Network 104 may include, for example, local area network (LAN), a wireless network such as mobile network, wireless local area network (WLAN) such as Wireless Fidelity (WiFi™), a wireless personal area network (WPAN) such as Bluetooth™ protocol and/or any other network or combination thereof.

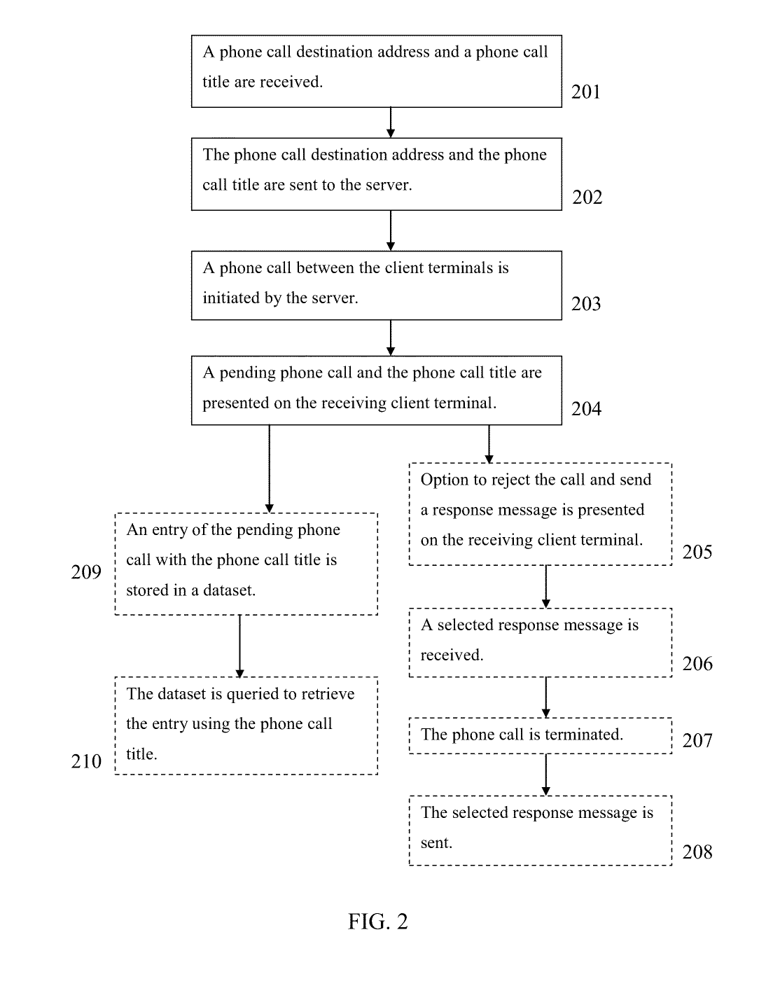

Reference is now made to FIG. 2, which is a flowchart schematically representing a method for presenting a title in an audio call such as a voice over internet protocol (VoIP) phone call, according to some embodiments of the present invention.

First, as shown in 201, a phone call destination address and a phone call title are received via a user interface of initiating client terminal 102.

The phone call destination address may be a phone number, a username, a name of a contact in the address book of initiating client terminal 102 and/or any other identification of receiving client terminal 103. Optionally, multiple phone call destination addresses of receiving client terminals may be received.

The phone call title may include any text, image(s), video, voice recording and/or combination thereof and may be textual or graphical call marker, multimedia phone call marker or call icon. The phone call title may include any information and/or question, for example: The phone call title may describe the subject of the phone call, for example, “I'm outside”, “wanted to tell you about the meeting” and/or an image indicating the subject. The phone call title may include a question to be answered in the phone call, for example, “Where are you?”, “Are we meeting tonight?”. The phone call title may include an indication of the urgency of the call, for example, “Please pick up the phone, urgent, don't have a key”, “Danny left, can talk now, not urgent”, “Emergency!”. The phone call title may include an indication of the caller ID, for example, “This is Shmuel, the one you talked to in the shop an hour ago”.

Optionally, the phone call title is selected from a user interface that present a set of optional phone call titles. The optional phone call titles are optionally adapted to an inputted phone call destination address. The adaptation may be performed based on an analysis of phone call titles previously selected for calls with the phone call destination address. The adaptation may be performed based on an analysis of emails, social network posts, SMS messages, and/or IM messages identified using the phone call destination address. The adaptation may be performed based on a current time (e.g. day or night and/or time of the week or the year). The adaptation may be performed based on an analysis, such as an NLP analysis of a data feed, such as a news feed. The adaptation may be performed based on a current status of the caller, for example a social network status or an availability status indicated using a user interface installed on his client.

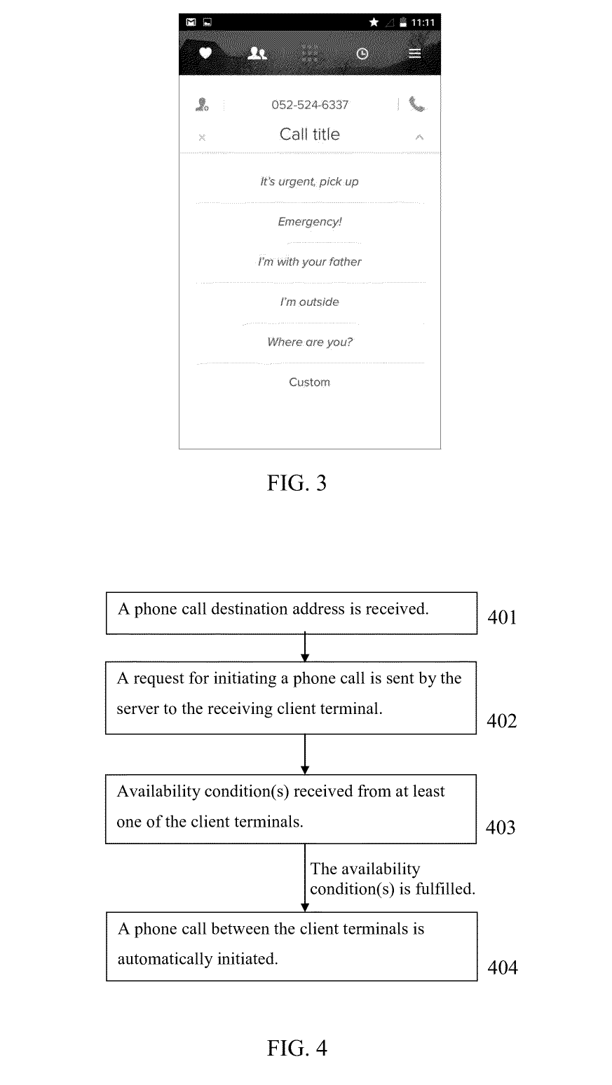

Reference is now made to FIG. 3, which is an exemplary user interface for selecting phone call title, according to some embodiments of the present invention. The interface includes suggested optional phone call titles that initiator 112 may choose from, so he may not need to type the text. Optionally, the suggested optional phone call titles are predefined by initiator 112. Optionally, the suggested optional phone call titles are selected from a dataset of optional phone call titles according to the identity of the receiver. For example, when receiver 113 is a family member of initiator 112, the suggested optional phone call titles includes phone call titles relating to family and/or home. Optionally, the suggested optional phone call titles are templates that are filled by initiator 112 according to the context of the phone call, for example, “Important, regarding XX” where XX is replaced by content typed by initiator 112 or completed from an analysis of calendar data, message data, or data feeds. Optionally, the suggested optional phone call titles are derived from previously used phone call titles.

Then, as shown in 202, the phone call destination address and the phone call title are sent from initiating client terminal 102 to server 101. This may be done by initiating client terminal 102 through network 104. This may be done by sending a message containing a phone call identifier, the phone call destination address and the phone call title.

Optionally, this is done by creating an invite packet of a voice over internet protocol (VoIP) phone call having a header, according to the data protocol used for the phone call, so the header includes the phone call title, and sending the invite packet to server 101.

Optionally, server 101 may prevent the use of phone call title from some users, for example according to permission definitions stored on server 101. In this case, a regular phone call is initiated by server 101.

Then, as shown in 203, a phone call from initiating client terminal 102 to receiving client terminal 103 is initiated by server 101, for example by using a data protocol.

Optionally, the phone call is initiated directly by initiating client terminal 102, and the phone call title is sent directly initiating client terminal 102 to receiving client terminal 103. This may be done, for example, by a peer-to-peer (P2P) communication protocol.

Then, as shown in 204, a pending phone call and the phone call title are presented on receiving client terminal 103. The pending phone call may also include caller ID of initiating client terminal 102. The phone call title may be presented on the screen of receiving client terminal 103, when the phone call title includes for example text and/or image, and/or may be played for example by speakers of receiving client terminal 103, when the phone call title includes for example a voice recording. When receiving client terminal 103 does not receive a phone call title, a regular pending phone call is presented.

Optionally, the phone call title may be defined or edited by receiver 113, using a user interface of receiving client terminal 103. This may be done during the phone call and/or after the phone call is over. For example, receiver 113 may edit the phone call title to better reflect the subjects discussed during the phone call.

Receiver 113 may then decide on his action regarding the phone call based on the phone call title. Receiver 113 has the option of accepting the pending phone call, rejecting the pending phone call, ignoring the pending phone call or rejecting the pending phone call and sending a message to initiator 112. The options may be presented on the user interface of receiving client terminal 103.

Optionally, as shown in 205, the option to reject the pending phone call and send a response message is presented on the user interface of receiving client terminal 103. Optionally, suggested optional response messages are also presented. Optionally, the suggested optional response messages are selected from a dataset of optional response messages according to the phone call title. This is done, for example, by identifying keywords in the phone call title. Optionally, the suggested optional response messages are selected from a dataset of optional response messages according to the caller ID and the phone call title. Optionally, the suggested optional response messages are selected according to a natural language processing (NLP) algorithm operated on the phone call title. Optionally, the suggested optional response messages are selected according to previously selected response messages by other users in response to previous phone call titles. This may be done, for example, by operating analysis algorithms on phone call titles and corresponding selected response messages. For example, when multiple users selected a response message: “I will be there in a minute” after presented with a phone call title: “Where are you?”, this optional response message is presented on receiving client terminal 103 when presenting this phone call title.

Optionally, the suggested optional response messages are templates that are filled by receiver 113 according to the context of the phone call, for example, “busy now but will have five minutes at XX” where XX is replaced by content typed by receiver 113 and/or by content suggested, for example, by accessing a calendar stored in receiving client terminal 103.

Then, as shown in 206, a selected response message, selected by receiver 113 using the user interface of receiving client terminal 103, is received. The phone call is then terminated and the selected response message is sent to initiating client terminal 102 by server 101, as shown in 207 and 208.

Optionally, the phone call title is sent during the phone call is ongoing between initiating client terminal 102 and receiving client terminal 103. Optionally, the phone call title is sent after the phone call is over.

Optionally, as shown in 209, an entry of the pending phone call is stored in a dataset 105. Dataset 105 may be stored in server 101, in initiating client terminal 102 and/or in receiving client terminal 103. The entry includes the phone call title and may also include other details of the phone call, such as caller ID of initiating client terminal 102, date, time and/or duration of the phone call, data retrieved from the conversation, analysis of the conversation such as produced for example by a sentiment engine and/or any other information. Optionally, when a response message is sent by receiving client terminal 103, the entry also includes the response message.

Optionally, as shown in 210, dataset 105 is queried to retrieve the entry of the phone call, using the phone call title. The querying may be done by initiator 112 and/or by receiver 113.

In an exemplary scenario of using the method, when David is calling Dan he may call Dan normally without a phone call title, in which case Dan will receive the pending phone call, knows it is from David and may decide what action to take. Alternatively David may add a title to the phone call, for example, “Tell me about the client”. Dan receives the pending phone call, knows it is from David and knows it has the call title “Tell me about the client”. Dan may then decide what action to take and has the additional information to make a more informed decision.

Reference is now made to FIG. 4, which is a flowchart schematically representing a method for completing a phone call under defined conditions, according to some embodiments of the present invention.

First, as shown in 401, a phone call destination address of receiving client terminal 103 is received from initiator 112 via a user interface of initiating client terminal 102. Optionally, multiple phone call destination addresses of receiving client terminals may be received.

Then, as shown in 402, a request for initiating a phone call is sent by server 101 to receiving client terminal 103.

The request may be, for example, a message sent to server 101 by of initiating client terminal 102. The request may also be a pending phone call, optionally with a phone call title. In this case, receiver 113 may reject the call at the current time, but set availability conditions for completing the call.

Then, as shown in 403, at least one availability condition is received from initiating client terminal 102 and/or from receiving client terminal 103. One or more conditions may be defined by initiator 112 and/or by receiver 113 by a user interface on initiating client terminal 102 and/or receiving client terminal 103 respectively.

The availability condition may include, for example, a predefined period of time such as “between 12:00 and 13:30”, or “after 17:00”. The availability condition may include a geographic location such as coordinated, “home” or “office” that is optionally identified by a location system of the client terminal such as global positioning system (GPS). The availability condition may include a portable location such as “in the car” that is identified for example by detected attachment of initiating client terminal 102 and/or receiving client terminal 103 to a car hands-free holder, by proximity sensor and/or by a noise detection algorithm. The availability condition may include absence of people other than initiator 112 and/or receiver 113 in proximity to initiating client terminal 102 and/or receiving client terminal 103 respectively, which may be identified for example by detection of talk voices by a noise detection algorithm. The availability condition may be updated continuously by initiator 112 and/or receiver 113 according to their current availability. The availability condition may include activity done by initiator 112 and/or receiver 113, for example, “eating launch” or “walking”, which may be identified, for example, by location system of the client terminal, by accessing a calendar stored in initiating client terminal 102 and/or receiving client terminal 103 respectively and/or by direct indication from initiator 112 and/or receiver 113.

The availability condition may include a required duration for the call, for example, “30 minutes” or “10 minutes”. The condition may then include expected availability of initiator 112 and/or receiver 113 for the duration of the call. This may be identified, for example, by accessing a calendar stored in initiating client terminal 102 and/or receiving client terminal 103 respectively and identifying a free period of time in the calendar. Optionally, the availability condition may include predicted duration of a journey, such as a car drive or a bus drive. This may be identified, for example, by information received from a GPS based application and/or may be set by initiator 112 and/or receiver 113.

Optionally, condition(s) defined by initiator 112 are presented to receiver 113, and vice versa. Optionally, initiator 112 and/or receiver 113 may indicate, by the user interface on initiating client terminal 102 and/or receiving client terminal 103 respectively, whether their defined availability condition(s) is presented to the other or not.

Then, as shown in 404, when the availability condition(s) is fulfilled, a phone call between initiating client terminal 102 and receiving client terminal 103 is automatically initiated.

In an exemplary scenario of using the method, when John calls Marry, she may agree to receive the call but she is not available at the current time. She may then receive the phone call under the condition of her and John both being available. Marry indicates that she is currently not available, by using a button that is shown with John's pending phone call. Five minutes later, John decides that he is not available so he indicates that he is currently not ready, by a user interface on his mobile phone. 7 minutes later Marry becomes available and therefore indicates that she is available. After another 10 minutes, John is available again and indicates that he is available. Then, both John and Marry are available and the phone call is automatically initiated.

According to some embodiments of the present invention, receiver 113 may accept the phone call and send a message to initiating client terminal 102, for example, when receiver 113 would like to indicate to initiator 112 that he is not alone. A single action of receiver 113 instructs receiving client terminal 103 both to accept the call and send the message. This may be done by the user interface of receiving client terminal 103 that allows receiver 113 to instruct simultaneously the reception of the phone call and the transmission of the message. The simultaneous instruction may include, for example, a single designated button press, a single finger press, a single finger gesture and/or a voice command. For example, the voice command “start” could indicate simple acceptation of the phone call while the voice command “go ahead” indicate acceptation of the phone call and also send a message “I am not alone”. This may also be used when receiving client terminal 103 presents a pending phone call with a phone call title. The message may be selected according to the phone call title, as described above.

In an exemplary scenario, Michael receives a pending phone call from Tom, and is presented with a keypad of buttons, each marked with a different user selected message, such as “I am not alone”, “Driving, so let's make it fast”, “Use mike@hmail(dot)com to send me stuff”. Then, Michael presses on one of the buttons to accept the call and to send the selected user selected message to Tom.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and systems of initiating a phone call will be developed and the scope of the term phone call is intended to include all such new technologies a priori.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method for presenting a title in an audio phone call, comprising:
receiving a phone call destination address and a phone call title from an initiating client terminal, said phone call destination address and said phone call title are received via a user interface of said initiating client terminal;
adapting said phone call title to said phone call destination address by modifying said title according to analysis of information associated with said phone call destination address;
initiating a phone call from said initiating client terminal to a receiving client terminal corresponding to said phone call destination address; and
sending said phone call title to said receiving client terminal to be presented on said receiving client terminal with an indication of a pending phone call and to be edited by a user of said receiving client terminal.

2. The method of claim 1, wherein said sending includes creating an invite packet having a header, said header includes said phone call title.

3. The method of claim 1, further comprising:
performing the following by said receiving client terminal:
presenting on a user interface of said receiving client terminal an option to reject said pending phone call and a subset of a plurality of optional response messages, said subset is selected from said plurality of optional response messages according to said phone call title;
receiving via said user interface of said receiving client terminal a selected response message from said subset;
terminating said pending phone call; and
sending said selected response message.

4. The method of claim 3, wherein said subset is selected according to a natural language processing (NLP) algorithm operated on said phone call title.

5. The method of claim 3, wherein said subset is selected according to previously selected response messages by a plurality of users in response to previous phone call titles.

6. The method of claim 1, further comprising:
storing an entry of said pending phone call in a dataset, said entry includes said phone call title; and
querying said dataset to retrieve said entry.

7. The method of claim 3, wherein said selected response message is stored in a dataset and included in an entry of said pending phone call.

8. The method of claim 1, wherein said receiving via said user interface includes:
presenting on said user interface a plurality of optional phone call titles; and
receiving via said user interface a selected phone call title from said plurality of optional phone call titles.

9. The method of claim 1, wherein said receiving via said user interface includes:
presenting on said user interface a subset of a plurality of optional phone call titles, said subset is selected from said plurality of optional phone call titles according to said phone call destination address; and
receiving via said user interface a selected phone call title from said subset.

10. The method of claim 1, wherein said receiving includes a plurality of phone call destination addresses corresponding to a plurality of receiving client terminals.

11. A non-transitory computer readable medium comprising computer executable instructions adapted to perform the method of claim 1.

12. A method for presenting a title in an audio phone call, comprising:
receiving from an initiating client terminal, a phone call destination address, said phone call destination address is received via a user interface of said initiating client terminal;
sending said phone call destination address from said initiating client terminal to a server;
initiating a phone call from said initiating client terminal to a receiving client terminal corresponding to said phone call destination address;
receiving from said initiating client terminal a phone call title, said phone call title received via said user interface;
identifying when said initiating client terminal is associated with a permission limitation on sending titles stored on said server; and
sending said phone call title to said receiving client terminal to be presented on said receiving client terminal, according to said permission limitation on sending titles.

13. A method for completing a phone call, comprising:
receiving from an initiating client terminal, a phone call destination address;
sending a request for initiating a phone call to a receiving client terminal corresponding to said destination address;
receiving at least one availability condition from said initiating client terminal; and
when said at least one availability condition is fulfilled, automatically initiating a phone call between said initiating client terminal and said receiving client terminal.

14. The method of claim 13, wherein said at least one availability condition includes a predefined time period.

15. The method of claim 13, wherein said at least one availability condition includes a location of said initiating client terminal.

16. The method of claim 13, wherein said at least one availability condition includes non-presence of other people in proximity to said initiating client terminal.

17. The method of claim 13, wherein said at least one availability condition includes a required duration for said phone call, wherein said duration is an available duration according to a calendar stored in said initiating client terminal.

18. The method of claim 13, wherein said at least one availability condition includes a required duration for said phone call, wherein said duration is a predicted duration of a journey.

19. The method of claim 13, wherein said at least one availability condition includes an activity performed by a user of said initiating client terminal.

20. The method of claim 13, wherein said at least one availability condition received from said initiating client terminal is presented on said receiving client terminal.

21. The method of claim 13, wherein an indication of fulfillment of some but not all of said at least one availability condition received from said initiating client terminal is presented on said receiving client terminal.

22. The method of claim 13, wherein said receiving includes a plurality of phone call destination addresses corresponding to a plurality of receiving client terminals.

23. A non-transitory computer readable medium comprising computer executable instructions adapted to perform the method of claim 13.

24. A system for completing a phone call, comprising:
an initiating client terminal that receives, via a user interface, a phone call destination address;
a receiving client terminal corresponding to said destination address that receives a request for initiating a phone call;
a server that receives at least one availability condition from said initiating client terminal; and when said at least one availability condition is fulfilled, automatically initiates a phone call between said initiating client terminal and said receiving client terminal.

25-26. (canceled)

27. The method of claim 1, wherein said adapting is according to analysis of phone call titles previously selected for phone calls with said phone call destination address.

28. The method of claim 1, wherein said adapting is according to analysis of at least one of emails, social network posts, SMS messages and IM messages associated with said phone call destination address.
